(19) United States
(12) Patent Application Publication
(10) Pub. No.: US 2005/0151807 A1
(43) Pub. Date: Jul. 14, 2005

(54) Ink container for an ink jet cartridge

(75) Inventors: Stephen A. Andersen, Thompson's Station, TN (US); Dennis M. Lengyel, Hemlock, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Nu-Kote International, Inc., a corporation of Delaware

(21) Appl. No.: 10/754,990

(22) Filed: Jan. 12, 2004

(51) Int. Cl. B41J 2/175

(52) U.S. Cl. 347/86

(57) ABSTRACT

An ink container for an inkjet cartridge comprises spaced apart side walls, a front wall, a rear wall and a bottom wall, and a partition dividing the interior into three ink chambers. Each chamber includes an outlet port in the bottom wall, and the front wall and bottom wall lie in generally perpendicular planes, and a planer guide wall extends between and at an angle to the front and bottom walls. Each chamber contains a block of ink absorbent material and a felt filter pad between the corresponding block and outlet port, and the container further includes a cover having a flat upper surface provided with serrations to enhance gripping the container.

### BACKGROUND OF THE INVENTION

This invention relates to the art of ink jet printers and, more particularly, to improvements in an ink container for an ink jet cartridge.

As is known, an ink jet cartridge comprises an ink container or tank removably received in a casing having ink tapping components in the bottom thereof for interconnection with ink outlet ports in the bottom wall of the container. The ink container is comprised of spaced apart side walls, a front wall, a rear wall, and a bottom wall, and the upper end of the container is closed by a cover which is heat sealed in place following the filling of the interior with ink. For color printing, the interior of the container is partitioned to define a plurality of chambers, each for a different color ink, and each of the chambers has an outlet port in the bottom wall for communication with a corresponding ink tapping component in the casing. The interior of each chamber is provided with a block of ink absorbing material which directly overlies the outlet port of the corresponding chamber, and the cover is provided with a vent to atmosphere for each of the chambers.

The casing which removably receives the ink container is comprised of a pair of spaced apart side walls, a rear wall, a bottom wall, and a front wall which extends upwardly a short distance from the bottom wall. The top and the upper portion of the front end of the casing are open to receive the ink container and to facilitate the introduction and removal thereof from the casing. The lower portion of the front wall of the ink container and the bottom wall of the latter are in planes which are perpendicular to one another, and the ink container is introduced into the casing by engaging the front wall of the container against the upper edge of the front wall of the casing and sliding the container inwardly of the casing while pivoting the container about the upper edge of the front wall of the casing while simultaneously engaging the lower rear corner of the container against the back wall of the casing until the container is fully seated in the casing with the outlet ports in the bottom wall interengaging with the ink tapping components in the casing. The upper front end of the container may be provided with an upwardly extending projection or tab which a user employs as a handle in connection with inserting and removing the container from the casing.

In an ink jet cartridge of the foregoing character, gripping of the container to facilitate insertion and removal thereof relative to the casing is difficult even though a projection or finger is provided at the upper end of the container to facilitate handling thereof. In this respect, the finger provides a single point of contact for a user's forefinger, and the latter can readily slide relative to the finger during manipulation of the container relative to the casing, whereby the user's control of the container and/or the stability with respect to the support of the container during manipulation thereof can be reduced or lost. Further, the guidance of the container into the casing by sliding the container inwardly across the upper edge of the front wall of the casing and then downwardly in sliding engagement with the rear wall of the casing causes the inserting movement to be cumbersome and requires two points of engagement between the container and casing during the majority of the inserting operation. Still further, the direct interfacing between the ink absorbing material and outlet ports in the ink chambers fails to provide adequate protection against contaminants being dispensed with the ink, such as contaminants in the ink and/or foam material and/or in the container from the manufacturing process. Moreover, there is a less than desirable flow of ink from the foam material or other absorbent media which results in wasted ink.

### SUMMARY OF THE INVENTION

In accordance with the present invention, an ink container is provided by which the foregoing and other disadvantages of ink containers heretofore available are advantageously minimized or overcome. More particularly in this respect, and in accordance with one aspect of the invention, an ink container for an ink jet cartridge has a cover at the upper end thereof providing a flat surface which is textured to facilitate stabilizing a user's handling and manipulation of the container during insertion and removal thereof relative to a casing. The texturing can be provided, for example, by serrations in the material of the cover, or a layer of rubber or the like on the top surface of the cover. Such texturing promotes frictional interengagement between the container and a user's finger and, preferably, the texturing extends partially across the top surface from the front end of the container towards the rear end thereof so as to optimize the area of available contact on the container for a user's finger. When the texturing is in the form of ribs or serrations integral with the cover they preferably extend transverse to the opposite sides of the container.

In accordance with another aspect of the invention, guidance of the insertion of an ink container into a casing of an ink jet cartridge is promoted by providing the lower portion of the front end of the ink container with a planar guide wall extending between and at an angle to the front and bottom walls of the container. The guide wall is adapted to slide along the upper edge of the front wall of the casing in a generally horizontal inward direction relative thereto and, thereafter, the container can be pivotal and lowered and simultaneously pivoted into the assembled position thereof with the casing.

In accordance with yet another aspect of the invention, a filtering pad is positioned in each of the ink chambers between the outlet port thereof and the corresponding ink absorbing block. The felt pad advantageously filters particulate material from the ink and/or foam or any particulate materials adhering to the walls of the container during the manufacturing and/or assembly process with respect thereto. Further, the felt pad has a high capillarity which allows for an increase flow of ink out of the corresponding outlet port, a higher efficiency of the absorbent media, and less wasted ink.

It is accordingly an outstanding object of the present invention to provide an improved ink container for an ink jet cartridge.

Another object is the provision of an ink container of the foregoing character wherein the ability to control and stabilize the container during manipulation thereof for insertion and removal relative to a casing of the ink jet cartridge is improved.

A further object is the provision of an ink container of the foregoing character wherein guidance of the container relative to the casing during insertion of the container thereinto is improved.

Yet another object is the provision of an ink container of the foregoing character with an improved ability to filter contaminants in the ink, ink absorbent media, and/or the container from flow with the ink from the container.

Still another object is the provision of an ink container of the foregoing character having a felt pad interposed between the ink absorbent block and outlet port of each ink chamber to provide a filter for the corresponding chamber and to promote control of the flow of ink from the chamber to promote faster printing and less wasted ink.

### BRIEF DESCRIPTION OF THE DRAWINGS

The foregoing objects, and others, will in part be obvious and in part pointed out more fully hereinafter in conjunction with the written description of preferred embodiments of the present invention illustrated in the accompanying drawings in which:

FIG. 1 is an exploded view of the component parts of an ink container in accordance with the invention and showing a transport clip for the container;

FIG. 2 is a side elevation view, in section, showing the component parts of the container and transport clip in assembled relationship;

FIG. 3 is a sectional elevation view taken along line 3-3 in FIG. 2;

FIG. 4 is a top view of the container with the cover, ink absorbent material, and filter components removed;

FIG. 5 is a top view of the cover component; and,

FIG. 6 illustrates a stage of the insertion of the ink container into a casing of an ink jet cartridge.

### DESCRIPTION OF PREFERRED EMBODIMENTS

Referring now in greater detail to the drawings, wherein the showings are for the purpose of illustrating preferred embodiments of the invention only, and not for the purpose of limiting the invention, an ink container is shown which comprises a shell 10 having a pair of spaced apart side walls 12 and 14, a front wall 16, a rear wall 18, and a bottom wall 20. Shell 10 is divided interiorly by a T-shaped partition 22 into three ink chambers 24, 26 and 28, each of which is provided with a corresponding outlet port 30 in bottom wall 20. Front wall 16 of the shell has upper and lower portions 16a and 16b, respectively, offset by an intermediate wall portion 16c. Front wall portion 16b and bottom wall 20 lie in planes which are generally perpendicular to one another and, for the purpose set forth hereinafter, a planar guide wall 32 extends between and at an angle x to front wall portion 16b and bottom wall 20. Preferably, angle x is 45°, and guide wall 32 intersects front wall portion 16b at a location spaced above the plane of bottom wall 20 from 15-16% of the height of shell 10 from bottom wall 20 to the upper ends of walls 12, 14, 16, and 18. Thus, for example, for a shell having a height of about 54.3 mm, guide wall 32 would intersect front wall portion 16b about 8.4 mm above the plane of bottom wall 20.

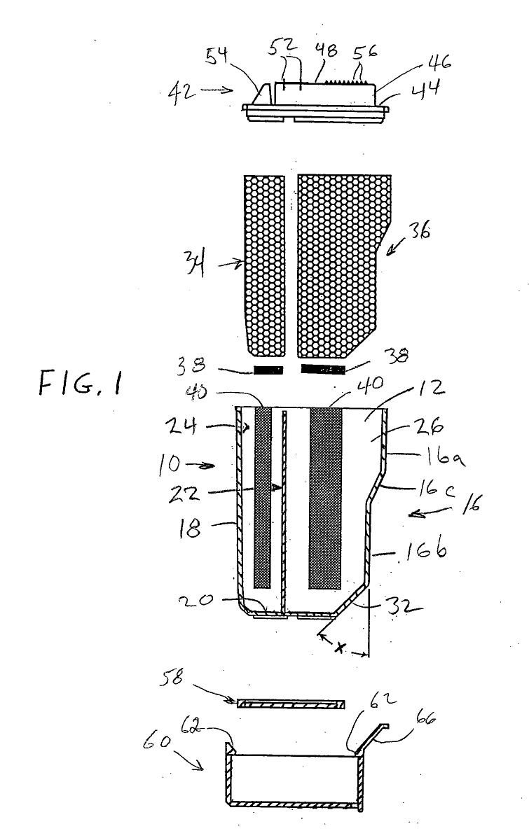

The ink container further includes a block of ink absorbent material 34 in chamber 24 and a block of ink absorbent material 36 in each of the chambers 26 and 28. A filter pad 38 of felt material is interposed between the bottoms of each of the blocks 34 and 36 and the inner side of bottom wall 20 of shell 10 and overlies the outlet port 30 of the corresponding chamber to remove particulate materials which may be in the ink and/or ink absorbent blocks and/or which may be in one or more of the chambers as residue from the manufacturing process. Preferably, the inner surfaces of the side, front and rear walls of the shell and the chamber surfaces defined by the partition walls are textured as indicated by the numeral 40 in association with side wall 12 in FIG. 1 to promote retention of the ink absorbent blocks in the ink chambers.

The ink container further includes a cover member 42 which is received in the upper end of shell 10 and secured thereto such as by heat welding. Cover 42 includes a peripheral flange 44 overlying the upper ends of the walls of the shell and an upwardly extending member 46 having a flat upper surface 48. The interior of flange 44 and member 46 are provided with a plurality of downwardly extending ribs 50 which engage against the top sides of absorbent material blocks 34 and 36 and provide an air space between the upper ends thereof and the upper end of the ink container as defined by the inner side of cover 42. Member 46 is also provided with a vent opening 52 for each of the ink chambers and pair of upwardly extending ribs which are 54 co-operable with the casing of an ink jet cartridge to retain the ink container therein. Further, the flat upper surface 48 of the cover is textured such as by the provision of a plurality of ribs or serrations 56 which are spaced apart in the direction between the front and rear wall and extend in the direction between side walls 12 and 14 of the shell. The texturing extends from a location adjacent the end of surface 48 adjacent front wall 16 to a location spaced from the front wall toward rear wall 18 which is generally centrally between the opposite ends of surface 48. While the texturing is shown as serrations it will be appreciated that other rib-like configurations can be used and that the texturing, which is intended to promote gripping and maneuvering of the ink container, as will become apparent hereinafter, can be defined other than by ribs in the material of the cover. In this respect, for example, the texturing could be provided by a layer of rubber-like material on surface 48.

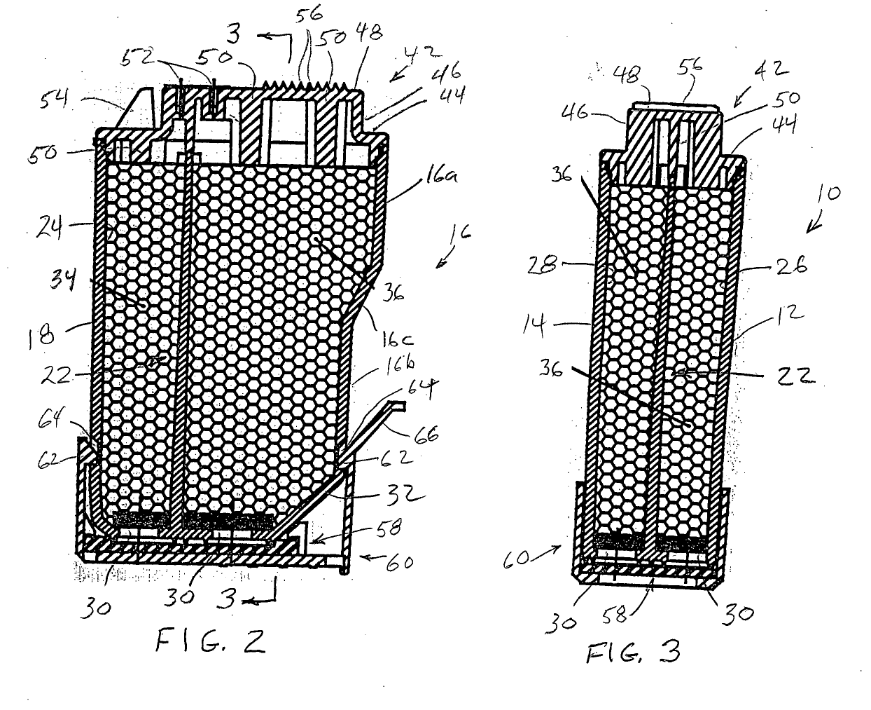

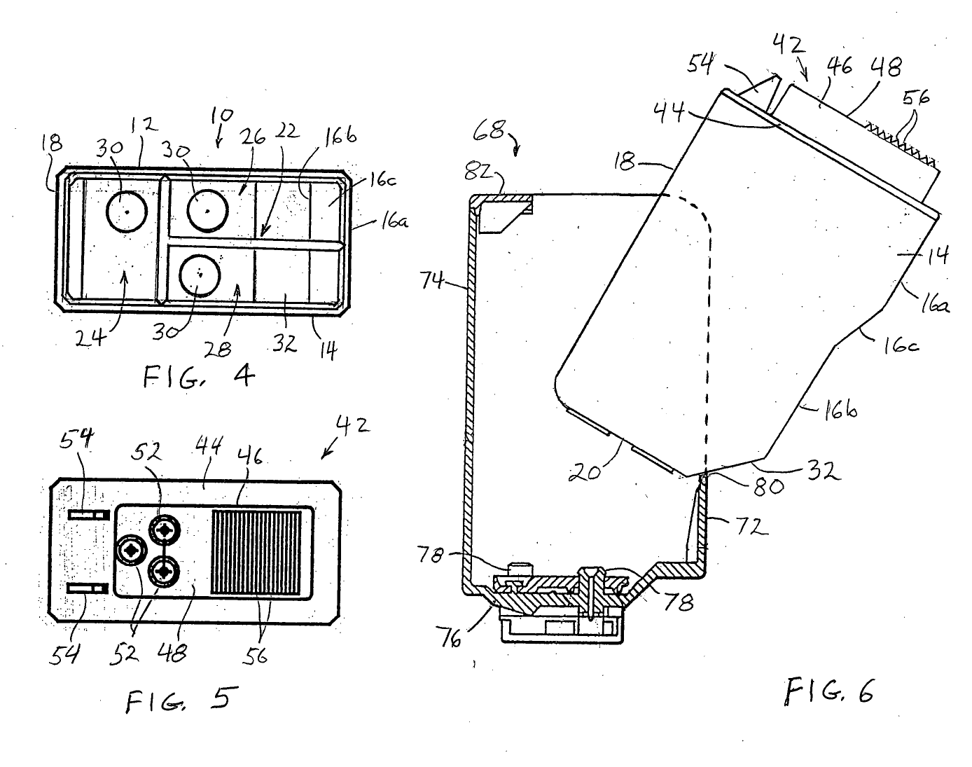

When the ink container is assembled and the chambers therein have been filled with ink, the lower end of the container is interconnected with a silicon sealing pad 58 and a cup-shaped transport clip 60 to close and seal the lower end of the container against leakage during shipment and storage. As will be appreciated from FIGS. 2 and 3, pad 58 engages against the underside of bottom wall 20 of the container shell, thus spanning the outlet ports through the bottom wall, and the front and rear walls of the transport clip are provided with inwardly extending tongues 62 which engage in corresponding notches 64 in the front and rear walls of the container shell to releasably retain the transport clip on the container. A finger tab 66 adjacent one of the tongues 62 facilitates displacement of the latter outwardly of the corresponding recess 64 to release the transport clip for removal from the container.

When the transport clip is removed from the container, the latter is introduced into a casing component 68 to provide an ink jet cartridge assembly. Casing 68 includes a pair of spaced apart side walls 70, only one of which is visible in FIG. 6, a front wall 72, a rear wall 74, and a bottom wall 76 on which an ink tapping components 78 are mounted for interengagement with the outlet port of the corresponding one of the three ink chambers, only two of which are visible in FIG. 6. Front wall 72 has an upper edge 80, and casing 68 is open at the top and at the front above wall 72. In accordance with one aspect of the invention, and as will be appreciated from FIG. 6, the ink container is introduced into casing 68 by engaging the lower end of guide wall 32 on upper edge 80 of front wall 72 and then sliding the ink container inwardly of the casing while simultaneously pivoting the container counterclockwise about edge 80 whereby, when the upper end of guide wall 32 reaches edge 80, the container can be essentially dropped vertically into the lower part of the casing by sliding the lower end of front wall portion 16b along edge 80 while continuing to pivot the container counterclockwise until the bottom end of the container interengages with tapping component 78 and tabs 54 interengage with upper end portion 82 of the casing to lock the container in place thereon. Advantageously, such insertion of the container into the casing using guide wall 32 and then the lower end of front wall portion 16b enables assembly of the components without having to engage the lower rear corner of the container with back wall 74 of the casing. Moreover, it will be appreciated that a user can grasp the upper front portion of the container between the thumb and second finger of his or her hand while placing the forefinger on serrations 56 so as to enable the user to stabilize and control manipulation of the container into its inserted position in the casing and, in part in this respect, the serrations optimize the stability and control by minimizing slippage between the user's forefinger and the container as the latter is manipulated into or removed from the casing.

While considerable emphasis has been placed herein on the preferred embodiments of the invention, it will be appreciated that other embodiments can be devised and that many modifications can be made with respect to the preferred embodiments without departing from the principals of the invention. Accordingly, it is to be distinctly understood that it is intended to include all such modifications as well as other embodiments insofar as they come within the scope of the appended claims or the equivalents thereof.

1. An ink container for an ink jet cartridge comprising spaced apart side walls, a front wall, a rear wall and a bottom wall, an outlet port in said bottom wall, said front wall and said bottom wall lying in generally perpendicular planes, and a planer guide wall extending between and at an angle to said front wall and said bottom wall.

2. An ink container according to claim 1, wherein said angle is about 45°.

3. An ink container according to claim 1, wherein the walls of the container have upper ends and said container has a height between said bottom wall and said upper ends, said guide wall intersecting said front wall at a location spaced above the bottom wall about 15% of said height.

4. An ink container according to claim 3, wherein said angle is about 45°.

5. An ink container for an ink jet cartridge comprising spaced apart side walls, a front wall, a rear wall and a bottom wall, a partition in said container dividing the interior thereof into a plurality of ink chambers, an outlet port in said bottom wall for each chamber, an ink absorbing member in each chamber, and a felt filter pad between each ink absorbing member and the corresponding outlet port.

6. An ink container according to claim 5, wherein said front wall and said bottom wall lie in generally perpendicular planes, and a planar guide wall extending between and at an angle to said front wall and said bottom wall.

7. An ink container according to claim 6, wherein said angle is about 45°.

8. An ink container according to claim 6, wherein the walls of the container have upper ends and said container has a height between said bottom wall and said upper ends, said guide wall intersecting said front wall at a location spaced above the bottom wall about 15% of said height.

9. An ink container according to claim 5, wherein the walls of the container have upper ends and said container has a height between said bottom wall and said upper ends, said guide wall intersecting said front wall at a location spaced above the bottom wall about 15% of said height, and said angle being about 45°.

10. An ink container according to claim 5, further including a cover having a generally flat upper surface, and texturing on said upper surface to facilitate gripping said container.

11. An ink container according to claim 10, wherein said upper surface of said cover has one end adjacent said front wall and an opposite end adjacent said back wall, said texturing extending from adjacent said one end to a location spaced from said one end toward said opposite end.

12. An ink container according to claim 11, wherein said location is generally centrally between said one and said opposite end.

13. An ink container according to claim 11, wherein said texturing includes ribs extending in the direction between said side walls.

14. An ink container according to claim 13, wherein said ribs include serrations and said location is generally centrally between said one and said opposite end.

15. An ink container for an ink jet cartridge comprising, spaced apart side walls, a front wall, a back wall, a bottom wall and a cover, said cover including a generally flat upper surface, and texturing on said upper surface to facilitate gripping said container.

16. An ink container according to claim 15, wherein said texturing includes ribs extending in the direction between said side walls.

17. An ink container according to claim 16, wherein said ribs include serrations.

18. An ink container according to claim 15, wherein said upper surface of said cover has one end adjacent said front wall and an opposite end adjacent said back wall, said texturing extending from adjacent said one end to a location spaced from said one end toward said opposite end.

19. An ink container according to claim 18, wherein said location is generally centrally between said one and said opposite end.

20. An ink container according to claim 18, wherein said texturing includes ribs extending in the direction between said side walls.

21. An ink container according to claim 20, wherein said ribs include serrations.

22. An ink container according to claim 18, wherein said front wall and said bottom wall lie in generally perpendicular planes, and a planer guide wall extending between and at an angle to said front wall and said bottom wall.

23. An ink container according to claim 22, wherein said upper surface of said cover has one end adjacent said front wall and an opposite end adjacent said back wall, texturing extending from adjacent said one end to a location spaced from said one end toward said opposite end, and said texturing including ribs extending in the direction between said side walls.

24. An ink container according to claim 23, wherein the walls of the container have upper ends and said container has a height between said bottom wall and said upper ends, said guide wall intersecting said front wall at a location spaced above the bottom wall about 15% of said height.

25. An ink container according to claim 24, wherein said angle is about 45°.

26. An ink container according to claim 22, further including a partition in said container dividing the interior thereof into a plurality of ink chambers, an outlet port in said bottom wall for each chamber, an ink absorbing member in each chamber, and a filter member between each ink absorbing member and the corresponding outlet port.

27. An ink container according to claim 26, wherein each filter member is a felt pad.

28. An ink container according to claim 26, wherein the walls of the container have upper ends and said container has a height between said bottom wall and said upper ends, said guide wall intersecting said front wall at a location spaced above the bottom wall about 15% of said height.

29. An ink container according to claim 28, wherein said angle is about 45°.

30. An ink container according to claim 26, wherein said upper surface of said cover has one end adjacent said front wall and an opposite end adjacent said back wall, said texturing extending from adjacent said one end to a location spaced from said one end toward said opposite end.

31. An ink container according to claim 30, wherein said location is generally centrally between said one and said opposite end, and said texturing including ribs extending in the direction between said side walls.

32. An ink container according to claim 31, wherein said front wall and said bottom wall lie in generally perpendicular planes, and a planer guide wall extending between and at an angle of about 45° to said front wall and said bottom wall.

33. An ink container according to claim 32, wherein the walls of the container have upper ends and said container has a height between said bottom wall and said upper ends, said guide wall intersecting said front wall at a location spaced above the bottom wall about 15% of said height.

34. An ink container according to claim 32, wherein said upper surface of said cover has one end adjacent said front wall and an opposite end adjacent said back wall, said texturing extending from adjacent said one end to a location generally centrally between said one and said opposite end, and said texturing including ribs extending in the direction between said side walls.

35. An ink container according to claim 34, wherein the walls of the container have upper ends and said container has a height between said bottom wall and said upper ends, said guide wall intersecting said front wall at a location spaced above the bottom wall about 15% of said height.

36. An ink container according to claim 35, wherein each filter member is a felt pad.
